(19) United States
(12) Patent Application Publication
(10) Pub. No.: US 2008/0038630 A1
(43) Pub. Date: Feb. 14, 2008

(54) Rechargeable AgO cathode

(76) Inventor: Michael Cheiky, Thousand Oaks, CA (US)

Correspondence Address: JONATHAN P. O'BRIEN / MILLER, CANFIELD,;PADDOCK AND STONE, 444 WEST MICHIGAN AVENUE, KALAMAZOO, MI, 49007, US

(21) Appl. No.: 11/090,471

(22) Filed: Mar. 25, 2005

(51) Int. Cl. H01M 2/14; H01M 4/34

(52) U.S. Cl. 429/131; 429/219

(57) ABSTRACT

The conductivity and rechargeability of silver oxide cathodes especially for secondary Ag-Zn batteries, is improved by coating silver oxide particles dispersed in an inert binder with a layer of an organic sulfonate especially a hydrophobic sulfonate such as a fluorinated alkyl sulfonate.

### TECHNICAL FIELD

This invention relates to improved cathodes for secondary silver batteries and, more particularly, this invention relates to coating silver oxide particles for use in a secondary silver-zinc battery in a manner to improve electrical conductivity of the particles and to improve rechargeability.

### BACKGROUND OF THE INVENTION

There is an ever increasing need for lighter, more powerful batteries. This is driven in part by devices such as laptops and cameras that demand more energy and power from lighter batteries. Silver-zinc batteries have long been recognized as possessing superior gravimetric and volumetric energy densities. The basic chemistry is described by the following formula:

AgO+Zn+H₂O →Zn(OH)₂+Ag

The cathode discharge process is characterized by two discrete steps:

2AgO+H₂O+2e⁻→Ag₂O+2OH⁻ (1)

Ag₂O+H₂O+2e⁻→2 Ag+2OH⁻ (2)

The first step, characterized by the discharge of the divalent silver oxide, occurs at 1.86V while the second step, that of the discharge of monovalent silver oxide, occurs at 1.59V.

The theoretical gravimetric and volumetric energy densities of batteries starting at the higher voltage of 1.86V are 524 Whr/kg and 900 Whr/L, respectively. The theoretical capacity of AgO is 430 mAhr/g versus 230 mAhr/g for Ag₂O. However, commercial silver-zinc batteries are not able to exploit the higher capacity of the divalent species in order to have a battery that is rechargeable enough to meet the needs of the marketplace.

For the past several decades commercial silver-zinc. batteries have been manufactured as primary cells. Up to now it has been difficult to recharge sealed divalent silver oxide batteries for various reasons. One of the reasons involves hydrogen gas production initiated at the zinc particle surfaces. This hydrogen can accumulate at the surfaces of the separator and cause significantly higher battery impedance. This problem has been solved problem with the invention of a recombinant separator as described in U.S. Pat. No. 6,733,920. The recombinant separator prevents hydrogen from accumulating at the site of origin by shuttling it to the cathodic recombination side. Another obstacle in the charging of silver-zinc batteries has been the decomposition of AgO in the presence of basic electrolyte, as indicated by the following formula:

AgO→Ag+½ O₂

For sealed systems this decomposition presents the danger of pressure buildup and case rupture. This problem is exacerbated by the poor electrical conductivity of AgO and Ag₂O, which leads to poor rechargeability. Thus a seemingly irreversible decomposition is established. These observations have led to the view that a cell containing divalent silver oxide is not rechargeable at all. Most practical charging schemes have thus so far involved reaching just the monovalent level while attaining 120 Whr/kg with unsealed cells.

### STATEMENT OF THE PRIOR ART

Prior workers in this field have focused on both reducing the rate of decomposition of AgO in the presence of the electrolyte and on improving the conductivity of AgO particles. Passaniti, et al. in U.S. Pat. No. 6,001,508, U.S. Pat. No. 5,589,109 and U.S. Pat. No. 5,389,469 disclose a modification of the outer surface of divalent silver oxide particles. The AgO particles are reacted with bismuth compounds to produce a surface compound containing silver, bismuth and oxygen. These silver bismuthate compounds are believed to decrease the impedance of the underlying divalent silver oxide without affecting the capacity of the divalent silver oxide.

A similar modification was effected by Megahed in U.S. Pat. No. 4,835,077 who reacts AgO with PbS in hot alkaline medium. U.S. Pat. No. 4,078,127 by Megahed et al describes using as an additive, a sulfide of cadmium, calcium, mercury, tin or tungsten to improve the stability of divalent silver oxide. Cahen in U.S. Pat. No. 3,017,448 describes the addition of lead compounds to the cathode in concentrations up to 5% to reduce gassing and improve the cell impedance. Fluoride, nitrate and sulfate anions have been disclosed as stabilizing agents for AgO in a review by McMillan in Chemical Reviews, 62 (1962) pages 65-80. The prior art, while improving the gassing performance and impedance of AgO, does not mention any improvements in the rechargeability of AgO in a secondary cell, instead focusing exclusively on improving the discharge capacity of primary cells.

### STATEMENT OF THE INVENTION

The present invention improves the rechargeability of divalent silver oxide by the use of additives that are believed to stabilize the higher oxidation state of divalent silver, improve the conductivity of Ag(I) ions and render Ag(I) more prone to accept electrons during charging of a battery with a silver oxide cathode.

The additives to the cathode can be selected from organic compounds containing sulfonic acid or sulfonate moieties. The organic sulfonic acid compounds or derivatives can include at least one member of the class R—SO₃H or R′—SO₃³¹M, where R, R′ can include, singly or in combination, any one of (CₓH_{y}F_{z}) where x can range from 1 to 12, y can range from 0 to 25, z can range from 0 to 25 and the sum of y+z is at least 3. They can also include at least one disulfonate compound of formula HO₃S—R′—R—SO₃H where R and R′ are as defined above.

The organic sulfonic acid compounds can also include, singly or in combination, polymers of formula —(R—SO₃H)ₙ— or —(R′—SO₃⁻M)ₙ— where R,R′ are as above and n is at least 2. They can also include perfluorinated sulfonic acid polymers such as Nafiono and Flemion®. M can be any metal or nonmetal cation, such as K⁺, Na⁺, Li⁺, Pb⁺², Ag⁺, NH4⁺, anilinium, Ba⁺², Sr⁺², Mg⁺², or Ca⁺². Preferred additives for use in this cathode of the invention include at least one compound selected methane sulfonic acid, the alkali metal salts of trifluoromethane sulfonate, and the alkali metal salts of perfluorobutane sulfonate.

The additive may be incorporated into the battery in various ways. It maybe added in bulk to the electrolyte which will saturate the cathode silver oxide layer, simply mixed in with the cathode paste, or added as a colloidal suspension. It may also be predissolved in a solvent. This solvent should be volatile compound or a mixture of volatile compounds that dissolve the sulfonate moiety and do not readily discharge the AgO. This solution may then be deposited onto the AgO particles in the form of spray or uniform coating. The solvent is then subsequently rapidly evaporated. Preferred solvents include ketones, esters or ethers. In another method, the additive may be separately complexed with the silver oxide prior to incorporation in the cathode layer. It has been found that a loading of the additive between 1% and 10% by weight of AgO provides efficacy. Loadings of the additive exceeding 10% by weight will impact the volumetric and gravimetric energy density without conferring any additional benefits. Loadings between 3 and 6% are preferred.

Optimal rechargeability necessitates using particles with sufficiently large surface area to facilitate conversion in a reasonable amount of time. Large grainy particles will neither discharge at the full capacity nor charge to full capacity in short periods of time. The present invention utilizes silver oxide particles preferably in the range between 10 nm and 10 μm, and most preferably in the range between 1 and 10 μm. To ensure better conductivity of the cathode, the particles may be optionally coated with a uniform layer of a conductive metal or metal oxide, such a layer of Pb or Bi.

While not being bound by theory, it is believed that the high oxidation states of silver are particularly stabilized by sulfonate moieties that have an extended hydrophobic ends. Besides stabilizing the AgO, these moieties improve the conductivity and render Ag(I) more prone to accept electrons during charging. It is also believed that the sulfonic acid moieties act, during electrolysis, as a precursor to a peroxydisulfate species, which is widely used to make the divalent silver oxide as demonstrated by the following reaction:

Ag₂O+Na₂S₂O₈+KOH→AgO+K₂SO4+H₂O

This reaction is known to be thermally activated, which can proceed in an electrolytic environment.

The silver oxide containing cathode of the invention demonstrates improved conductivity. Batteries containing the cathode of the invention exhibit an improvement in rechargeability.

These and many other features and attendant advantages of the invention will become apparent as the invention becomes better understood by reference to the following detailed description when considered in conjunction with the accompanying drawings.

### BRIEF DESCRIPTION OF THE DRAWINGS

FIG. 1 is a schematic side view in section of the cathode according to the invention; and

FIG. 2 is a schematic view in section of a secondary silver-zinc battery containing the cathode according to the invention.

### DETAILED DESCRIPTION OF THE INVENTION

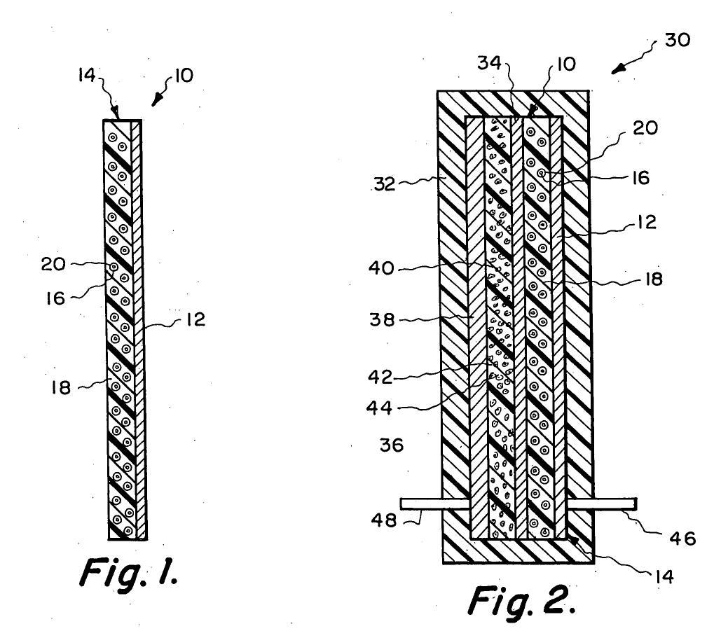

Referring now to FIG. 1 the cathode 10 of the invention includes a high surface area current collector 12 such as a metal screen or an expanded metal substrate of a metal such as silver, silver plated copper or brass supporting a cathode layer 14. The cathode layer 14 is formed of a pressed or sintered mixture of a binder polymer 16 resistant to attack by the alkaline environment of the battery and to the redox electrical reactions during charging and recharging of a battery containing silver oxide particles 18. The silver oxide particles are coated with a layer 20 of the sulfonate additive.

Referring now to FIG. 2 a secondary battery 30 includes a gas and liquid impervious case 32 containing a cathode 10 as described in FIG. 1, a porous separator 34 and a conventional zinc anode 36 previously used in Ag-Zn batteries formed of an anode current collector 38 and anode paste or layer 40 formed of a matrix polymer 42 containing a dispersion of Zn and ZnO particles 44. Terminals 46, 48 are connected to the cathode and anode current collector 12 and 38 respectively.

The following examples illustrate the construction of rechargeable AgO cathodes.

### EXAMPLE 1

260 mg of Potassium trifluoromethanesulfonate and 40 mg of potassium perfluorobutane sulfonate and 5 mg of potassium perfluoroduodecane sulfonate were dissolved in 3 ml of acetone. The resulting solution was evenly distributed on 10.0 g of divalent silver oxide particles of nominal particle size 1.0 μm. The solvent quickly evaporated, and did not interfere with the activity of the silver oxide. The coated silver oxide particles were mixed with Teflon (Polytetrafluorothylene) binder and alkaline electrolyte such as potassium hydroxide. The mixture was pressed together at 10,000 psi. When tested with a cathode formed by the same procedure but absent the sulfonate additives, the cathode containing the additives demonstrated improbed conductivity and rechargeability.

### EXAMPLE 2

Example 1 was followed as above, except that the solution of the sulfonates was added to AgO precoated with Pb. The conductivity of the resulting cathode was improved.

### EXAMPLE 3

200 mg of methane sulfonic acid was added to 2 ml of electrolyte (aqueous KOH) of specific gravity 1.45. This electrolyte was added to a mixture of 10.0 g of divalent silver oxide, Teflon binder and oxidation resistant fibers and pressed together at 5,000 psi. Again, conductivity and rechargeability were improved.

### EXAMPLE 4

5.0 g of a Dupont DE-1020 Nafion® PFSA polymer dispersion, comprised of approximately 10% perfluorosulfonic acid/PTFE copolymer and 90% water, is evenly sprayed on 10.0 g of AgO. The water is gently evaporated. The coated AgO is mixed with hydrophilic fibers and electrolyte and pressed to 10,000 psi. The polymeric sulfonate polymer addition to the cathode layer improved conductivity and rechargability.

It is to be realized that only preferred embodiments of the invention have been described and that numerous substitutions, modifications and alterations are permissible without departing from the spirit and scope of the invention as defined in the following claims.

What is claimed is:

1. A cathode for a secondary battery comprising in combination;
a dispersion of silver oxide particles in a polymeric binder resistant to alkaline electrolyte and oxidation by silver oxide, the outside surface of said particles being coated with a layer of an organic compound containing a moiety selected from the group consisting of sulfonic acid and sulfonate.

2. A cathode according to claim 1 in which the organic compound is present in an amount of between 1% and 10% by weight of silver oxide.

3. A cathode according to claim 2 in which the organic compound is present in an amount of 3% to 6% by weight of silver oxide.

4. A cathode according to claim 3 in which the silver oxide particles have a size between 10 nm and 10 μ.

5. A cathode according to claim 4 in which the particles have a size between 1 and 10 μ.

6. A cathode according to claim 1 in which the silver oxide particles are precoated with a layer of a member selected from the group consisting of a conductive metal and a conductive metal oxide.

7. A cathode according to claim 6 in which the metal is selected from the group consisting of lead and bismuth.

8. A cathode according to claim 1 in which the additive is a fluoride-substituted alkylsulfate or sulfonate containing from 1 to 6 carbon atoms.

9. A cathode according to claim 1 in which the additive is a fluoro-substituted polymer.

10. A cathode according to claim 1 in which the organic sulfonic acid compound is selected from at least one member of the class selected from: R—SO₃H, R′SO₃M, HO₃S—R′RSO₃H, (R—SO₃H) n, R′ISO₃M)n which R and R′ is selected from at least one member of the group consisting of (Cₓ H_{y} F_{z}) where x is a number between 1 to 12, y is a number between 0 and 25, z is a number from 0 and 25, the sum of y+z is at least 3, n is at least 2 and M is a metal or non-metal cation.

11. A cathode according to claim 10 in which M is selected from the group consisting of K+′ Na⁺, Li⁺ Pb⁺², Ag⁺, NH⁺₄, anilinium, Ba⁺², Si⁺², Mg⁺² and Ca⁺².

12. A cathode according to claim 10 in which the organic compound is selected from at least one member of the group consisting of methane sulfonic acid, alkali metal salts of trifluoromethane sulfonate and alkali metal salts of perfluoro-butane sulfonate.

13. A cathode according to claim 1 in which the dispersion is mounted on a current collector.

14. A battery comprising in combination;
a cathode as defined in claim 13;
an anode including a layer comprising a dispersion of zinc and zinc oxide in an inert binder mounted on a current collector;
a separator disposed between the anode and cathode;
an alkaline electrolyte;
a case enclosing the anode cathode separator and electrolyte, and terminals mounted on the case connected to the anode and cathode.
